(19) United States
(12) Patent Application Publication
(10) Pub. No.: US 2025/0314770 A1
(43) Pub. Date: Oct. 9, 2025

(54) OBJECT DETECTION DEVICE AND OBJECT DETECTION METHOD

(71) Applicant: Hino Motors, Ltd., Tokyo (JP)

(72) Inventors: Kento TOSHIMA, Hino-shi (JP); Kozue KOBAYASHI, Hino-shi (JP)

(73) Assignee: Hino Motors, Ltd., Tokyo (JP)

(21) Appl. No.: 19/070,600

(22) Filed: Mar. 5, 2025

(30) Foreign Application Priority Data
Apr. 4, 2024 (JP) 2024-060642

(51) Int. Cl. G01S 17/66; G01S 7/48; G01S 17/42; G01S 17/931

(52) U.S. Cl. CPC G01S 17/66; G01S 7/4808; G01S 17/42; G01S 17/931

(57) ABSTRACT

An object detection device according to one aspect includes: a point cloud data acquisition unit configured to acquire point cloud data generated by a laser sensor; an object detection unit configured to periodically acquire position information on a tracking target object, based on the point cloud data; a tracking unit configured to input the position information on the tracking target object to a Kalman filter in a first period and output a predicted value of a position or speed of the tracking target object in a second period shorter than the first period; and a tracking control unit configured to change an output timing of the predicted value from the tracking unit or a tracking duration for the tracking target object, based on a variance of the predicted value.

### CROSS-REFERENCE TO RELATED APPLICATIONS

This application is based on and claims the benefit of priority from Japanese Patent Application No. 2024-060642 filed on Apr. 4, 2024, the entire contents of which are incorporated herein by reference.

### TECHNICAL FIELD

The present disclosure relates to an object detection device and an object detection method.

### BACKGROUND

Japanese Unexamined Patent Publication No. 2017-129446 describes an object detection device including: a LiDAR configured to transmit a laser and acquire a plurality of measurement points, based on reflection of the laser; a clustering unit configured to cluster the plurality of measurement points into one or a plurality of clusters; a cluster tracking unit configured to track the clusters, using a Kalman filter; a shape model fitting unit configured to fit the clusters to a shape model; a shape model tracking unit configured to track movement of the shape model, using the Kalman filter; and an object detection unit configured to detect an object, based on a result of tracking the shape model.

### SUMMARY

In a laser sensor such as the LiDAR used in the above object detection device, output data including an imprecise measured value may sometimes be generated due to the influence of environmental noise, multiple-reflection noise, or the like. When imprecise output data is generated, in some cases, a false image (noise image) that does not actually exist may be erroneously tracked as a tracking target object, or processing of tracking the tracking target object may be stopped because the tracking target object is temporarily lost. If precise tracking of the tracking target object is blocked, safe control of the vehicle may be possibly hindered.

Thus, an object of the present disclosure is to provide an object detection device and an object detection method capable of improving tracking accuracy for a tracking target object.

An object detection device according to one aspect includes: a point cloud data acquisition unit configured to acquire point cloud data generated by a laser sensor; an object detection unit configured to periodically acquire position information on a tracking target object, based on the point cloud data; a tracking unit configured to input the position information on the tracking target object to a Kalman filter in a first period and output a predicted value of a position or speed of the tracking target object in a second period shorter than the first period; and a tracking control unit configured to change an output timing of the predicted value from the tracking unit or a tracking duration for the tracking target object, based on a variance of the predicted value.

The Kalman filter sequentially updates the variance of the predicted value, based on the measured value of the position information on the tracking target object and the predicted value of the position of the tracking target object. The variance of the predicted value indicates the degree of variation of the predicted value, that is, the uncertainty of the predicted value. In other words, a smaller variance of the predicted value indicates higher reliability of the predicted value, and conversely, a larger variance of the predicted value indicates lower reliability of the predicted value. In the object detection device according to the present aspect, the output timing of the predicted value from the tracking unit or the tracking duration for the tracking target object is determined based on the variance of the predicted value, that is, the reliability of the predicted value. The reliability of the predicted value output from the tracking unit may be enhanced, and as a result, the tracking accuracy for the tracking target object may be improved.

The tracking control unit may control the tracking unit to output the predicted value when the variance of the predicted value becomes equal to or less than a threshold. By outputting the predicted value when the variance of the predicted value becomes equal to or less than the threshold, the reliability of the predicted value output from the tracking unit may be enhanced.

The tracking control unit may control the tracking unit such that the tracking duration increases as the variance of the predicted value decreases. When the variance of the predicted value is low, the actually existing tracking target object is highly likely to be being tracked. In this case, by increasing the tracking duration, the tracking target object may be continuously tracked even if the input to the Kalman filter is temporarily interrupted.

An object detection method according to one aspect includes: acquiring point cloud data generated by a laser sensor; periodically acquiring position information on a tracking target object, based on the point cloud data; inputting the position information on the tracking target object to a Kalman filter in a first period and outputting a predicted value of a position or speed of the tracking target object in a second period shorter than the first period; and changing an output timing of the predicted value or a tracking duration for the tracking target object, based on a variance of the predicted value.

According to various aspects of the present disclosure, tracking accuracy for a tracking target object may be improved.

### BRIEF DESCRIPTION OF THE DRAWINGS

FIG. 1 is a side view illustrating a vehicle in which an object detection device is equipped;

FIG. 2 is a block diagram illustrating a functional configuration of the object detection device according to an embodiment;

FIG. 3 is a block diagram schematically illustrating a functional configuration of a Kalman filter;

FIG. 4 illustrates an example of a variance output from the Kalman filter; and

FIG. 5 is a flowchart illustrating an object detection method according to an embodiment.

### DETAILED DESCRIPTION

Hereinafter, embodiments of the present disclosure will be described with reference to the drawings. In the description of the drawings, the same elements are denoted by the same reference signs, and redundant description will be omitted. A part of the drawings may sometimes be drawn in a simplified or exaggerated manner for easy understanding, and dimensional ratios, angles, and the like are not limited to those expressed in the drawings.

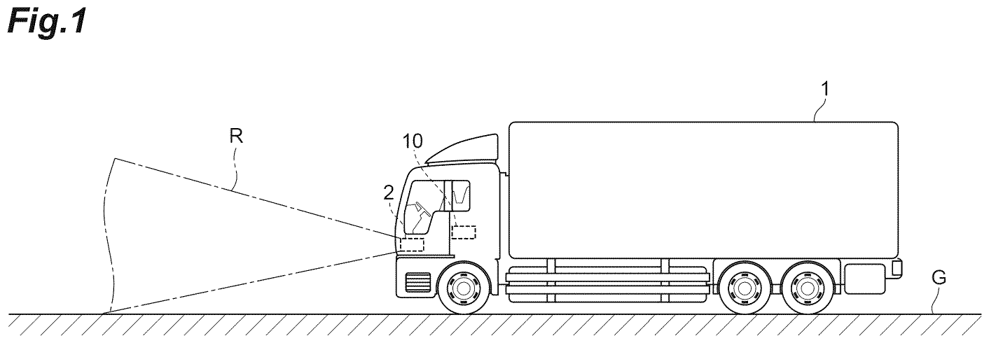

FIG. 1 is a side view illustrating a vehicle 1 in which an object detection device 10 according to an embodiment is equipped. The vehicle 1 is a large-sized vehicle such as a truck, a cargo vehicle, or a bus vehicle and is typically an autonomous driving vehicle that autonomously travels without being operated by a human driver. Hereinafter, an example in which the vehicle 1 is an autonomous driving truck will be described. In the following description, a forward direction and a backward direction of the vehicle 1 will be referred to as a front-rear direction of the vehicle 1, and a left-right direction when the vehicle 1 is viewed from the rear will be referred to as a vehicle width direction. A direction perpendicular to the vehicle width direction and the front-rear direction will be referred to as a vertical direction.

The vehicle 1 includes a laser sensor 2 and the object detection device 10. As illustrated in FIG. 1, the laser sensor 2 is equipped in the vehicle 1, irradiates an irradiation region R around the vehicle 1 with laser light, receives reflected light of the laser light, and detects a distance to an object present around the vehicle 1. The object as a target to be detected is, for example, an obstacle such as a pedestrian, a bicycle, another vehicle, and a fixed structure (a building, a tunnel, an overpass, a sign, a plant, or the like). In the embodiment illustrated in FIG. 1, the laser sensor 2 irradiates an area ahead of the vehicle 1 with laser light, but an irradiation direction of the laser light is not limited to the area ahead. For example, the laser sensor 2 may irradiate areas in all directions in a horizontal plane with laser light.

As the laser sensor 2, for example, laser imaging detection and ranging (LiDAR) is used. The LiDAR performs scanning with a laser in the vertical direction and a horizontal direction and outputs position information on an object or environment on three-dimensional coordinates at each measurement position, as point cloud data. The point cloud data is a set of measurement points including measurement results. That is, each measurement point of the point cloud data includes three-dimensional position information on the object.

The object detection device 10 is equipped in the vehicle 1. The object detection device 10 is a computer including a processor, a storage device, a communication device, and the like. The object detection device 10 loads, for example, a program stored in a storage device and executes the loaded program with a processor to implement various sorts of functions to be described later. Note that the object detection device 10 is not necessarily be configured by a computer operated by a program, and a part or the whole of the function of the object detection device 10 may be mounted on an application specific integrated circuit (ASIC) in which logic circuits are integrated.

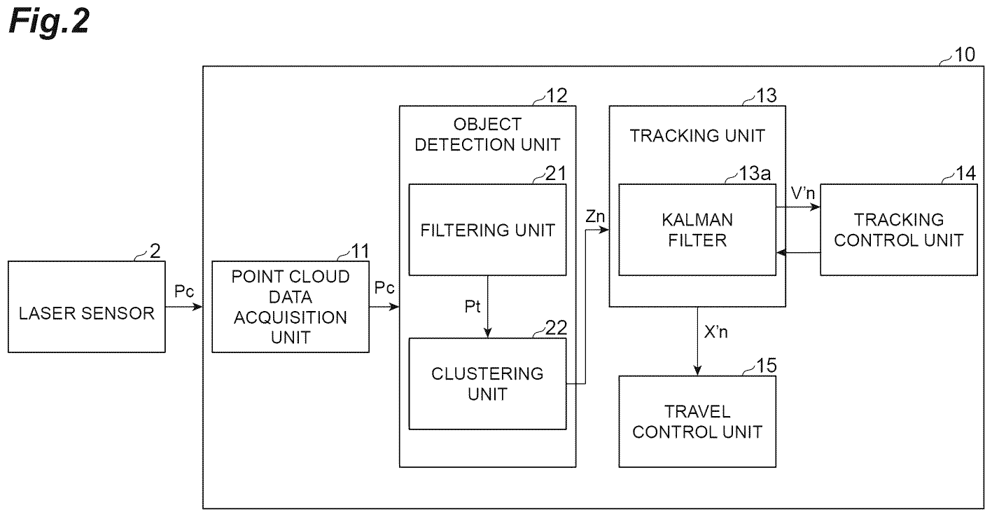

FIG. 2 is a block diagram illustrating a functional configuration of the object detection device 10 according to the embodiment. The object detection device 10 detects a tracking target object, based on the point cloud data generated by the laser sensor 2, and tracks the tracking target object to periodically output predicted values of the position and speed of the tracking target object.

As illustrated in FIG. 2, the object detection device 10 includes a point cloud data acquisition unit 11, an object detection unit 12, a tracking unit 13, a tracking control unit 14, and a travel control unit 15.

The point cloud data acquisition unit 11 acquires point cloud data Pc of an object in the irradiation region R generated by the laser sensor 2. The point cloud data Pc acquired by the point cloud data acquisition unit 11 is output to the object detection unit 12.

The object detection unit 12 recognizes an object that is the tracking target object, based on the point cloud data Pc. As illustrated in FIG. 2, the object detection unit 12 includes a filtering unit 21 and a clustering unit 22.

The filtering unit 21 executes ground filter processing of extracting a point cloud indicating a ground G from the point cloud data Pc. The ground filter processing is a technique of separating a point cloud of the ground from a point cloud of a non-ground and removing the point cloud of the ground from the point cloud data Pc generated by the LiDAR. Known algorithms such as a Scan Ground Filter, a RANSAC Ground Filter, and a Ray Ground Filter are common for the ground filter processing.

For example, in the Scan Ground Filter, the point cloud data Pc is grouped in the horizontal direction and sorted by the distance from the LiDAR. Next, the lowest measurement point in the sorted point clouds is selected as a candidate for the ground G, a nearby measurement point is searched for according to the candidate point for the ground G, and a measurement point within a threshold range is classified as a measurement point indicating the ground G. By iteratively executing the above processing, a set of measurement points classified as the ground is extracted as a point cloud indicating the ground G. The filtering unit 21 periodically outputs a point cloud Pt obtained by removing the point cloud indicating the ground G from the point cloud data Pc to the clustering unit 22.

The clustering unit 22 executes clustering processing on the point cloud Pt in which the point cloud indicating the ground G has been removed from the point cloud data Pc. In the clustering processing, a collection of a spatially adjacent point cloud is classified as one cluster (group), and each cluster is specified as an object. As an approach for the clustering processing, for example, a k-means method, a Density-Based Spatial Clustering of Applications with Noise (DBSCAN) method, a Mean Shift method, hierarchical clustering, or the like is used.

The clustering unit 22 periodically outputs position information on the object specified by the clustering processing to the tracking unit 13 in a first period. The object specified by the clustering unit 22 is the tracking target object. Note that the clustering unit 22 may specify the type of the tracking target object, based on the position, size, shape, and the like of the cluster. The clustering unit 22 periodically outputs, for example, information indicating a center position of the cluster to the tracking unit 13 as position information on the tracking target object.

The tracking unit 13 includes a Kalman filter 13a and inputs the position information on the tracking target object output from the clustering unit 22 to the Kalman filter 13a in the first period, to periodically output a predicted value of the position or speed of the tracking target object in a second period. In the following description, the predicted value of the position of the tracking target object will be sometimes referred to as an estimated position, and the predicted value of the speed of the tracking target object will be sometimes referred to as an estimated speed. The estimated speed is a velocity vector including a moving direction. The tracking unit 13 outputs an identifier for identifying the tracking target object in association with the estimated position and the estimated speed in the second period. The second period is a shorter period than the first period.

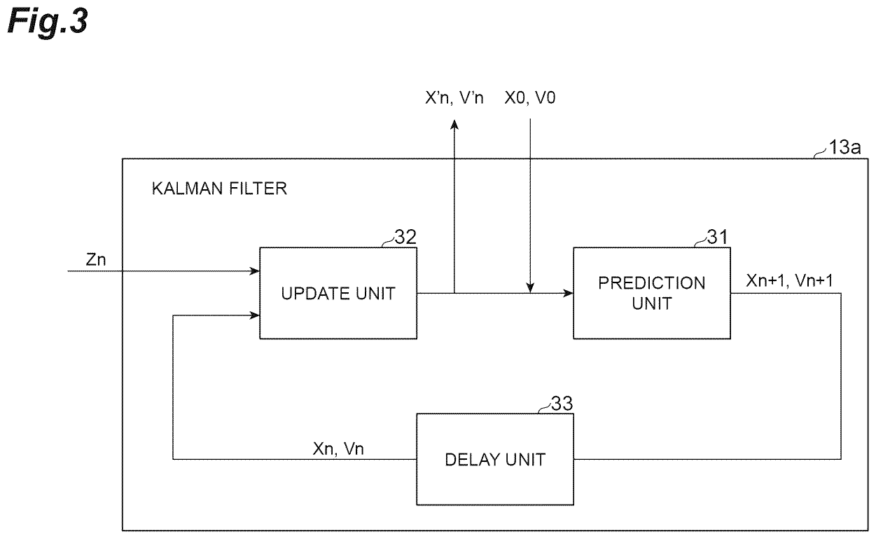

The Kalman filter 13a repeats prediction of the position and speed of the tracking target object and update of the predicted values of the position and speed, to output the estimated position and estimated speed of the tracking target object. FIG. 3 is a block diagram schematically illustrating a functional configuration of the Kalman filter 13a. As illustrated in FIG. 3, the Kalman filter 13a includes a prediction unit 31, an update unit 32, and a delay unit 33 as functional components.

For example, when predicting the position and speed of the tracking target object using the Kalman filter 13a, the tracking unit 13 inputs initial values X0 of the position and speed of the tracking target object and initial values V0 of variance values to the prediction unit 31 and initializes the Kalman filter 13a. Next, the prediction unit 31 generates predicted values Xn+1 (n=1, 2, . . . , N) of the position and speed of the tracking target object at a next time point, using the initial values X0 and a state transition matrix, and also updates the variances to Vn+1. For example, when the state transition matrix representing a prediction model is assumed as F and a transposed matrix of the state transition matrix F is assumed as FT, the variance Vn+1 is represented by the following Formula (1).

$$Vn + 1 = F \cdot Vn \cdot FT \qquad ( 1 )$$

Next, the tracking unit 13 inputs position information Zn on the tracking target object output from the clustering unit 22 to the update unit 32 and updates the predicted values Xn and the variances Vn, based on an observation error between the measured position information Zn and the predicted values Xn input via the delay unit 33. Then, the tracking unit 13 outputs the updated predicted values X′n and variances V′n. For example, when an observation matrix for converting the predicted value Xn into an observation space is assumed as H, a Kalman gain that is a matrix representing a correction amount of the predicted value Xn is assumed as K, and an identity matrix is assumed as I, the variance V′n is represented by the following Formula (2).

$$V ’ n = ( I - K \cdot H ) \cdot Vn \qquad ( 2 )$$

As described above, the Kalman filter 13a repeats prediction and update of the predicted values Xn and the variances Vn and periodically outputs the predicted values X′n and the variances V′n of the position and speed of the tracking target object. The variance V′n output from the Kalman filter 13a is also called posterior covariance.

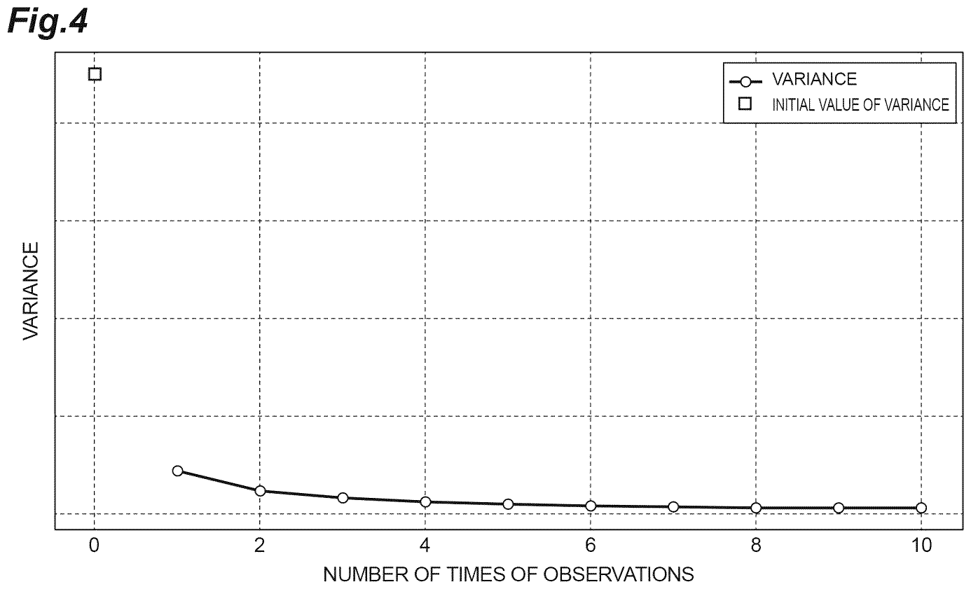

FIG. 4 illustrates an example of the variance V′n output from the Kalman filter 13a. As illustrated in FIG. 4, the variance V′n tends to decrease as the number of times of observing the tracking target object (the number of times of inputting the position information Zn) increases. This means that the reliability of the predicted value X′n is enhanced as the number of times of inputting the position information Zn on the tracking target object increases and the update of the predicted value is repeated.

The tracking unit 13 outputs the variances V′n generated by the Kalman filter 13a to the tracking control unit 14 and outputs the predicted values X′n to the travel control unit 15. Note that a tracking duration for the tracking target object is set in the Kalman filter 13a. The tracking duration indicates time from when the input of the measured position information Zn on the tracking target object to the Kalman filter 13a from the object detection unit 12 is stopped to when the output of the predicted values X′n is stopped. That is, when the tracking duration has elapsed since the stop of the input of the position information Zn on the tracking target object, the tracking unit 13 stops the tracking of the tracking target object and stops the output of the predicted values X′n.

The tracking control unit 14 changes the output timing of the predicted values X′n from the tracking unit 13 or the tracking duration for the tracking target object, based on the variances V′n. For example, the tracking control unit 14 controls the tracking unit 13 to output the predicted values X′n to the travel control unit 15 from the tracking unit 13 when the variances V′n of the predicted values X′n become equal to or less than a threshold. The tracking control unit 14 also controls the tracking unit 13 to increase the tracking duration as the variances V′n decrease.

The travel control unit 15 controls the vehicle 1, based on the predicted values X′n of the tracking target object, that is, the estimated position and the estimated speed of the tracking target object. For example, the travel control unit 15 determines a desired speed and a desired steering angle of the vehicle 1 according to the estimated position and the estimated speed of the tracking target object and controls various sorts of actuators of the vehicle 1 to achieve the determined desired speed and desired steering angle.

As described above, the Kalman filter sequentially updates the variance of the predicted value, based on the predicted value of the position of the tracking target object and the measured value of the position information. The variance of the predicted value indicates the degree of variation of the predicted value and is an index representing the uncertainty of the predicted value. That is, a smaller variance of the predicted value indicates higher reliability of the predicted value, and conversely, a larger variance of the predicted value indicates lower reliability of the predicted value. In the object detection device 10, the output timing of the predicted value from the tracking unit or the tracking duration for the tracking target object is determined based on the variance of the predicted value. This may enhance the reliability of the predicted value output from the tracking unit, and as a result, the tracking accuracy for the tracking target object may be improved.

For example, consider a case where the object detection unit 12 recognizes a false image that does not actually exist, as the tracking target object, due to noise. Usually, a false image appears suddenly and disappears immediately. Therefore, immediately after the false image is recognized, the variance output from the Kalman filter 13a is set to the initial value V0, which is a value larger than the threshold. In this case, the tracking control unit 14 delays the output timing of the predicted values X′n of the position and speed of the tracking target object until the variances V′n become smaller than the threshold, such that the output of the information indicating the estimated position and the estimated speed of the false image to the travel control unit 15 is suppressed. Consequently, the reliability of the predicted value output from the tracking unit 13 may be enhanced. As a result, the travel control unit 15 may be allowed to avoid performing erroneous control such as escaping from the false image.

The travel control unit 15 also controls the tracking unit to increase the tracking duration as the variance of the predicted value decreases. For example, even when there is an obstacle between the vehicle 1 and the tracking target object and the input of the position information Zn on the tracking target object is temporarily interrupted, the tracking target object is highly likely to actually exist if the variance of the predicted value is low because measurement values have been input a plurality of times in the past. In this case, by increasing the tracking duration, the tracking target object may be continuously tracked even when the input of the position information Zn on the tracking target object to the Kalman filter 13a is temporarily interrupted.

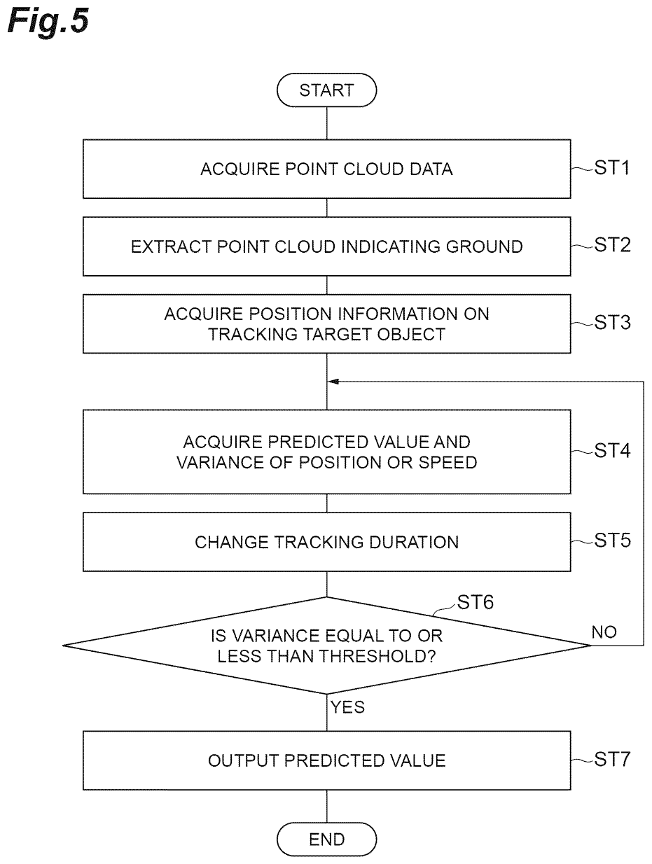

Next, an object detection method according to an embodiment will be described. FIG. 5 is a flowchart illustrating the object detection method according to the embodiment. This detection method is executed by the object detection device 10 described above.

As illustrated in FIG. 5, in this detection method, the point cloud data acquisition unit 11 acquires the point cloud data Pc generated by the laser sensor 2 (step ST1). Next, the filtering unit 21 extracts a point cloud indicating the ground G from the point cloud data Pc (step ST2). The filtering unit 21 outputs the point cloud Pt obtained by removing the point cloud indicating the ground G from the point cloud data Pc to the clustering unit 22.

Next, the clustering unit 22 executes the clustering processing on the point cloud Pt in which the point cloud indicating the ground G has been removed from the point cloud data Pc, to specify the tracking target object, and acquires the position information Zn on the specified tracking target object (step ST3).

Next, the tracking unit 13 inputs the position information Zn on the tracking target object to the Kalman filter 13a in the first period to output the predicted value X′n of the position or speed of the tracking target object in the second period (step ST4). At this time, the Kalman filter 13a calculates the variance V′n of the predicted value X′n.

Next, the tracking control unit 14 changes the tracking duration by the tracking unit 13 for the tracking target object, based on the variance V′n (step ST5). For example, the tracking control unit 14 makes the tracking duration for the tracking target object shorter as the variance V′n is higher and makes the tracking duration for the tracking target object longer as the variance V′n is lower. When the tracking duration becomes longer, the interval in which the predicted values X′n of the position and speed of the tracking target object are continuously output while the position information Zn on the tracking target object is not input from the object detection unit 12 becomes longer.

Next, the tracking control unit 14 verifies whether the variance V′n is equal to or less than the threshold (step ST6). When the variance V′n is larger than the threshold, the processing in steps ST4 and ST5 is repeated until the variance V′n becomes equal to or less than the threshold. On the other hand, when the variance V′n is equal to or less than the threshold, the predicted value X′n is output to the travel control unit 15 from the tracking unit 13 (step ST7).

Next, the travel control unit 15 controls the travel of the vehicle 1, using the predicted values X′n of the position and speed of the tracking target object output from the tracking unit 13 (step ST8). For example, the travel control unit 15 determines a desired speed and a desired steering angle of the vehicle 1 according to the estimated position and the estimated speed of the tracking target object and controls various sorts of actuators of the vehicle 1 to achieve the determined desired speed and desired steering angle.

While the object detection device 10 and the object detection method according to various embodiments have been described above, various modifications not limited to the above-described embodiments may be made without changing the gist of the invention.

For example, in the above embodiments, description has been made assuming that the vehicle 1 is an autonomous driving vehicle, but the vehicle 1 does not have to be an autonomous driving vehicle. In this case, the information regarding the position and speed of the object detected by the object detection device 10 can be used for driving assistance (preceding vehicle following function or the like) of the vehicle 1.

In the above embodiments, the tracking unit 13 outputs the predicted values of the position and speed of the tracking target object, but may simply output the predicted value of at least one of the position and the speed of the tracking target object. Note that the various embodiments described above may be combined unless otherwise contradicted.

### REFERENCE SIGNS LIST

2 Laser sensor
10 Object detection device
11 Point cloud data acquisition unit
12 Object detection unit
13 Tracking unit
13a Kalman filter
14 Tracking control unit
Pc Point cloud data

What is claimed is:

1. An object detection device comprising:
a point cloud data acquisition unit configured to acquire point cloud data generated by a laser sensor;
an object detection unit configured to periodically acquire position information on a tracking target object, based on the point cloud data;
a tracking unit configured to input the position information on the tracking target object to a Kalman filter in a first period and output a predicted value of a position or speed of the tracking target object in a second period shorter than the first period; and
a tracking control unit configured to change an output timing of the predicted value from the tracking unit or a tracking duration for the tracking target object, based on a variance of the predicted value.

2. The object detection device according to claim 1, wherein the tracking control unit controls the tracking unit to output the predicted value when the variance of the predicted value becomes equal to or less than a threshold.

3. The object detection device according to claim 1, wherein the tracking control unit controls the tracking unit to increase the tracking duration as the variance of the predicted value decreases.

4. An object detection method comprising:
acquiring point cloud data generated by a laser sensor;
periodically acquiring position information on a tracking target object, based on the point cloud data;
inputting the position information on the tracking target object to a Kalman filter in a first period and outputting a predicted value of a position or speed of the tracking target object in a second period shorter than the first period; and
changing an output timing of the predicted value or a tracking duration for the tracking target object, based on a variance of the predicted value.
